(19) United States
(12) Patent Application Publication
(10) Pub. No.: US 2025/0010388 A1
(43) Pub. Date: Jan. 9, 2025

(54) JIGSAW

(71) Applicant: MILWAUKEE ELECTRIC TOOL CORPORATION, Brookfield, WI (US)

(72) Inventor: John M. Jubeck, Mequon, WI (US)

(21) Appl. No.: 18/760,178

(22) Filed: Jul. 1, 2024

Related U.S. Application Data
(60) Provisional application No. 63/512,524, filed on Jul. 7, 2023.

(51) Int. Cl. B23D 49/16

(52) U.S. Cl. CPC B23D 49/165

(57) ABSTRACT

A jigsaw including a housing, a handle extending transverse from the housing in a direction along a handle axis, a battery selectively coupled to the handle, a foot plate configured to contact a workpiece during a cutting operation, a drive assembly powered by the battery and including a motor, a transmission driven by the motor, an output spindle driven by the transmission and coupled to a saw blade. The jigsaw further includes a scotch yoke mechanism to convert a rotational motion of the transmission to a reciprocating motion of the output spindle and the saw blade generally along a vertical axis that is perpendicular to the handle axis, wherein the scotch yoke mechanism includes a bushing eccentrically mounted to a driven gear of the transmission. The bushing includes a spherical bearing surface received within a laterally extending slot of the output spindle for sliding movement therewith.

### CROSS-REFERENCE TO RELATED APPLICATIONS

This application claims priority to prior-filed U.S. Provisional Patent Application No. 63/512,524, filed on Jul. 7, 2023, the entire content of which is incorporated herein by reference.

### FIELD OF THE INVENTION

The present invention relates to power tools, and more specifically to jigsaws.

### BACKGROUND OF THE INVENTION

Various power tools, such as jigsaws, often incorporate a mechanism in the drivetrain to convert rotational movement to reciprocating movement. In some instances, that mechanism is a scotch yoke mechanism, which converts rotational movement of the motor to reciprocating movement of the saw blade.

### SUMMARY OF THE INVENTION

The present invention provides, in one aspect, a jigsaw including: a housing; a handle extending substantially transverse from the housing in a direction along a handle axis; a battery selectively coupled to the handle; a foot plate coupled to the housing and configured to contact a workpiece during a cutting operation; a drive assembly powered by the battery and including a motor, a transmission driven by the motor, an output spindle driven by the transmission and coupled to a saw blade; and a scotch yoke mechanism to convert a rotational motion of the transmission to a reciprocating motion of the output spindle and the saw blade generally along a vertical axis that is perpendicular to the handle axis, wherein the scotch yoke mechanism includes a bushing eccentrically mounted to a driven gear of the transmission, the bushing includes a spherical bearing surface received within a laterally extending slot of the output spindle for sliding movement therewith.

The present invention provides, in another aspect, a drive assembly for a jigsaw configured to cut a workpiece during a cutting operation, the jigsaw including: a motor that rotates about a first axis; an output spindle driven by the motor along a second axis and coupled to a saw blade; and a scotch yoke mechanism to convert a rotational motion of the motor to a reciprocating motion of the output spindle and the saw blade generally along the second axis that is perpendicular to the first axis, wherein the scotch yoke mechanism includes a bushing that orbitally rotates about the first axis, the bushing includes a spherical bearing surface received within a laterally extending slot of the output spindle for sliding movement therewith.

The present invention provides, in another aspect, a drive assembly for a jigsaw configured to cut a workpiece during a cutting operation, the jigsaw including: a motor; an output spindle coupled to a saw blade and driven by the motor along an axis that is generally perpendicular to the workpiece; and a scotch yoke mechanism disposed between the motor and the output spindle and configured to convert a rotational motion of the motor to a reciprocating motion of the output spindle and the saw blade, wherein the scotch yoke mechanism includes a bushing having a spherical bearing surface received within a laterally extending slot of the output spindle for sliding movement therewith.

Other features and aspects of the invention will become apparent by consideration of the following detailed description and accompanying drawings.

### BRIEF DESCRIPTION OF THE DRAWINGS

FIG. 1 is perspective view of a jigsaw in accordance with an embodiment of the invention.

FIG. 2 is a partially exploded perspective view of the jigsaw of FIG. 1.

FIG. 3 is a perspective view of a drive assembly of the jigsaw of FIG. 1, illustrating a motor, a transmission, an output spindle, and a scotch yoke mechanism disposed between the transmission and the output spindle.

FIG. 4 is a cross-sectional view of the jigsaw taken along line 4-4 of FIG. 2, illustrating the drive assembly.

FIG. 5 is a perspective view of a portion of the drive assembly of the jigsaw of FIG. 1, illustrating the scotch yoke mechanism and a counterweight that counterbalances the movement of the output spindle.

FIG. 6 is a cross-sectional view of a portion of the scotch yoke mechanism, illustrating the output spindle swinging relative to a vertical axis.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

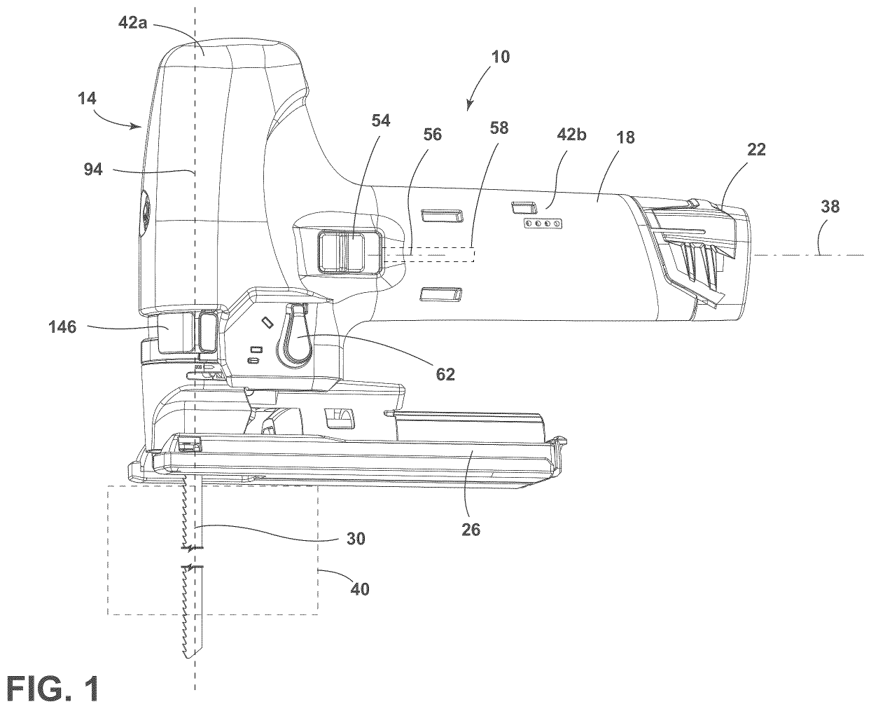

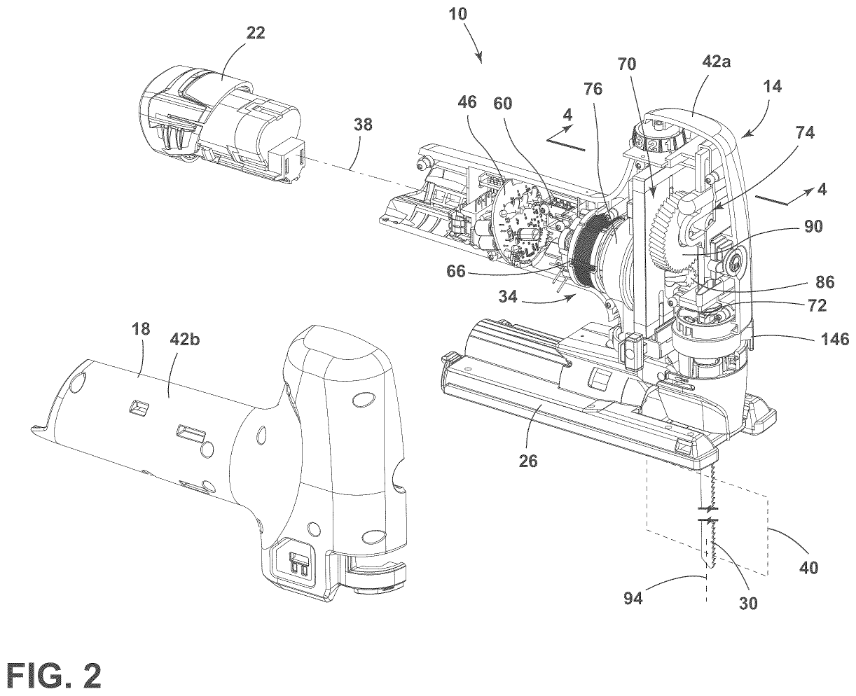

FIG. 1 illustrates a power tool, such as a jigsaw 10, including a housing 14, a handle 18 extending from the housing 14 in a substantially transverse direction, a battery 22 selectively coupled to the handle 18, a foot plate 26 pivotably coupled to the housing 14 and configured to contact a workpiece during a cutting operation, and a saw blade 30 protruding from the housing 14 and the lower surface of the foot plate 26. The jigsaw 10 includes a drive assembly 34 (FIG. 2) powered by the battery 22 and operable to impart reciprocating motion to the saw blade 30 for cutting of a workpiece. The jigsaw 10 defines a handle axis 38 extending in the direction of the handle 18. Moreover, the saw blade 30 generally reciprocates within a blade plane 40 during a cutting operation.

With reference to FIGS. 1 and 2, the handle 18 receives the battery 22 along the handle axis 38 and supports a controller 46. The controller 46 is disposed between the battery 22 and the drive assembly 34 in a direction along the handle axis 38. The jigsaw 10 also includes gripping surfaces 42a, 42b disposed on the housing 14 and the handle 18, respectively, that are graspable by a user to operate and maneuver the jigsaw 10 relative to a workpiece. The gripping surfaces 42a, 42b, in addition to the housing 14 and the handle 18, are composed of a non-conductive material (e.g., plastic with or without an elastomeric overmold). Such a non-conductive material electrically insulates the user should the user inadvertently cut an electrical wire during a cutting operation, thus inhibiting, or at least mitigating, an electrical shock.

With continued reference to FIGS. 1 and 2, the jigsaw 10 further includes an activation switch 54 in electrical communication with the controller 46 to selectively supply power to the drive assembly 34. Specifically, the activation switch 54 provides an input to the controller 46 which, in turn, directs electrical current from the battery 22 to the drive assembly 34. The activation switch 54 is provided adjacent the handle 18 and is slidable along a switch axis 56 between an activated state, in which the battery 22 supplies electrical current to the drive assembly 34, and a deactivated state, in which the drive assembly 34 is deactivated. The switch axis 56 is parallel to the handle axis 38 of the jigsaw 10 (FIG. 1). The activation switch 54 is coupled to a linkage 58 that is disposed on the interior of the housing 14 and is moveable with the activation switch 54. The linkage 58 is parallel to the handle axis 38 and is configured to interact with a limit switch 60 (FIG. 2), which is in electrical communication with the controller 46 and closes a circuit when depressed via the linkage 58 to activate a motor 66. As such, the linkage 58 slides along a direction parallel to the handle axis 38 to engage and disengage the limit switch 60 during the activated state and the deactivated state, respectively.

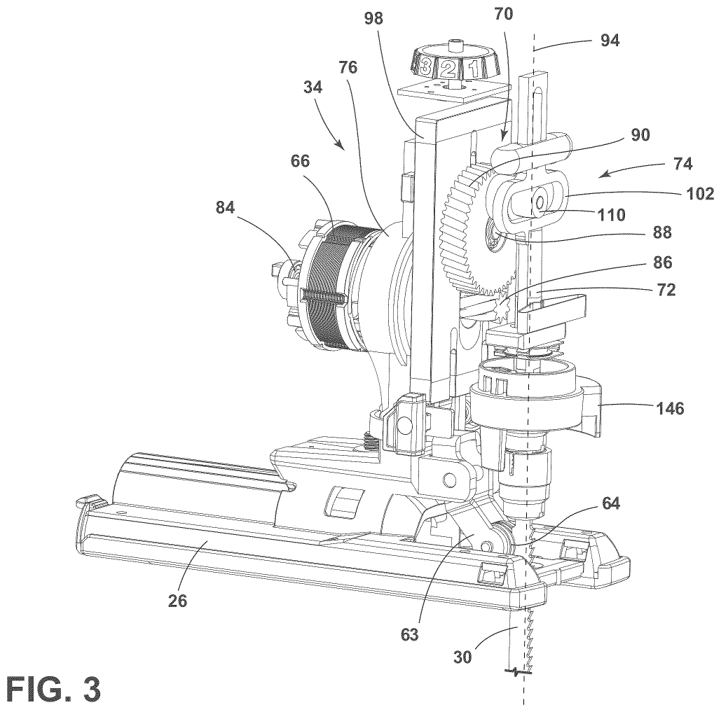

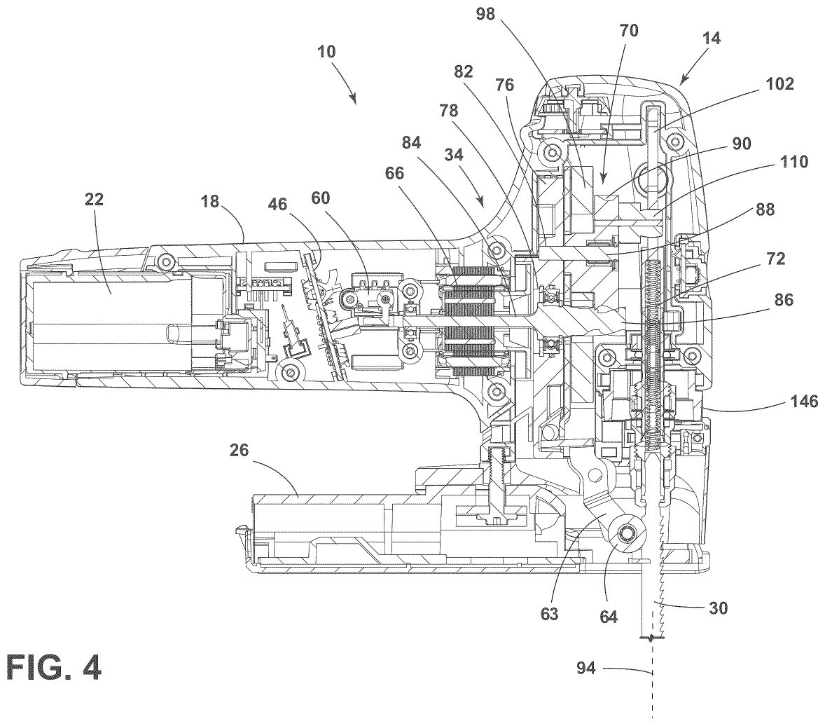

A mode selector switch 62 (FIG. 1) is disposed on the housing 14 and allows a user to switch the jigsaw 10 between an orbital cutting mode and a straight cutting mode. FIGS. 3 and 4 illustrate a support arm 63 that supports the saw blade 30 during the orbital cutting mode and the straight cutting mode. Specifically, at a distal end of the support arm 63 is a wheel 64 that engages the saw blade 30 and reduces friction as the saw blade 30 reciprocates relative to the support arm 63. As such, the support arm 63 and the wheel 64 collectively and selectively impart an orbit motion to the saw blade 30 during a return (i.e., cutting) stroke of the saw blade 30.

With reference to FIGS. 3 and 4, the drive assembly 34 of the jigsaw 10 is disposed within the housing 14 and the handle 18. The drive assembly 34 includes the motor 66, a transmission 70 driven by the motor 66, an output spindle 72 to which the saw blade 30 is removably secured, and a scotch yoke mechanism 74 that transfers the rotational motion of the transmission 70 to a reciprocating motion of the output spindle 72, as described in further detail below. A frame 76 is disposed within the housing 14 and supports the motor 66 and the transmission 70 within the housing 14. The frame 76 is composed of a non-conductive material (e.g., plastic) like the housing 14 and the handle 18. Such a non-conductive material electrically insulates the user should the user inadvertently cut an electrical wire during a cutting operation, thus inhibiting, or at least mitigating, an electrical shock. As shown in FIG. 4, the frame 76 includes first and second apertures 78, 82 that support the motor 66 and the transmission 70, respectively. Specifically, the first aperture 78 receives and supports a drive shaft 84 of the motor 66 which, in turn, supports a helical drive gear 86. The second aperture 82 receives and supports a driven shaft 88 of a helical driven gear 90 of the transmission 70. The helical drive gear 86 intermeshes and drives the helical driven gear 90 of the transmission 70. Due to the rotational motion of the transmission 70 being converted to the reciprocating motion of the output spindle 72 via the scotch yoke mechanism 74, the saw blade 30 is also driven in a reciprocating manner along a vertical axis 94 during the straight cutting mode. The vertical axis 94 is perpendicular to the handle axis 38.

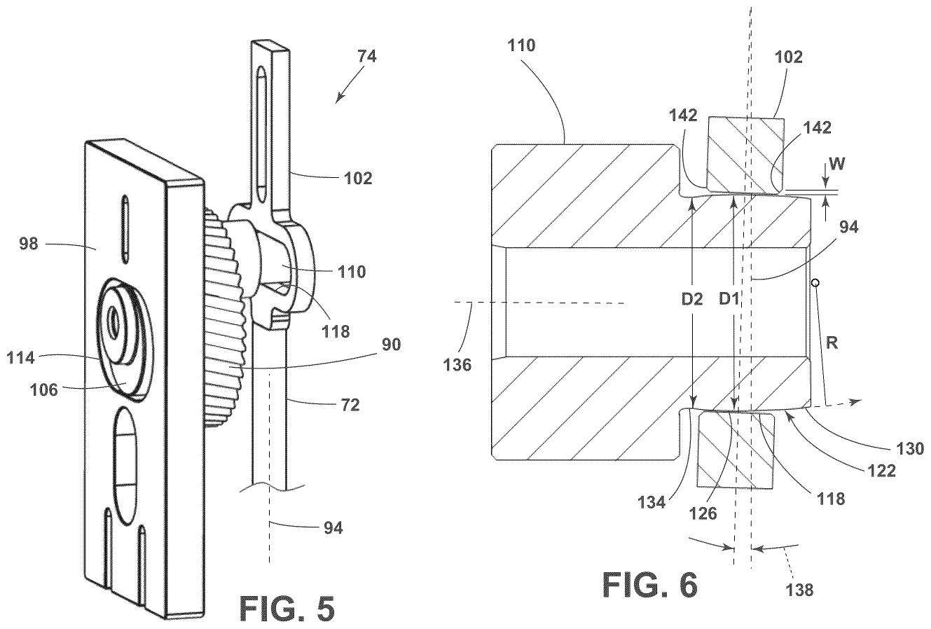

With reference to FIG. 5, the scotch yoke mechanism 74 is configured in a manner to increase the longevity of the drive assembly 34. The scotch yoke mechanism 74 coverts the rotational motion of the transmission 70 to a reciprocating motion of the output spindle 72, as previously mentioned. The scotch yoke mechanism 74 includes a counterweight 98 and a slider portion 102 of the output spindle 72. The counterweight 98 and the output spindle 72 reciprocate opposite of each other parallel to and along the vertical axis 94, respectively, during the straight cutting mode. Through opposite reciprocation, the counterweight 98 effectively dampens the mass and acceleration of the saw blade 30 and the output spindle 72 to inhibit jumping of the jigsaw 10 relative to a workpiece. The saw blade 30, the output spindle 72, and the slider portion 102 reciprocate together generally along the vertical axis 94 during the straight cutting mode. The scotch yoke mechanism 74 further includes a cam 106 and a bushing 110, which are disposed radially opposite of each other on the helical driven gear 90. Specifically, the cam 106 is eccentrically mounted to the driven shaft 88 of the driven gear 90, and the bushing 110 is disposed on the driven gear 90 radially opposite from the cam 106. The counterweight 98 is driven by the cam 106 and the slider portion 102—and thus, the output spindle 72—is driven by the bushing. Specifically, the cam 106 is received within an elongated slot 114 of the counterweight 98, such that rotational (i.e., orbital) movement of the cam 106 results in reciprocating movement of the counterweight 98. Similarly, the bushing 110 is received within a laterally extending slot 118 of the slider portion 102, such that rotational (i.e., orbital) movement of the bushing 110 results in reciprocating movement of the slider portion 102 and the output spindle 72.

With reference to FIG. 6, the bushing 110 includes a bearing surface 122 that is engaged with the laterally extending slot 118. The bearing surface 122 is convex or spherical in shape rather than cylindrical, such that the bearing surface 122 bulges radially outward. Specifically, an apex 126 of the bearing surface 122 has a first diameter D1 that is greater than a second diameter D2 of first and second ends 130, 134 of the bearing surface 122, creating the bulging or spherical shape. In other words, the bushing 110 has a convex cross-sectional shape in a plane containing a central axis 136 of the bushing 110 (as shown in FIG. 6), such that the bearing surface 122 is radiused. The radius of curvature R of the bearing surface 122 is approximately 25 to 35 millimeters. Specifically, the radius of curvature R of the bearing surface 122 is 30 millimeters. The bulged shape of the bearing surface 122 facilitates the slider portion 102 of the output spindle 72 to rock (i.e., swing) off the vertical axis 94. When the jigsaw 10 is operating in the orbital cutting mode, the output spindle 72 swings forward and backward relative to the vertical axis 94 by an angle 138, which is facilitated by the support arm 63 contacting the saw blade 30. The angle 138 is approximately one to four degrees. Specifically, the angle 138 is two degrees. More specifically, the angle 138 is 1.8 degrees. The laterally extending slot 118 also includes a chamfered edge 142 so that the slider portion 102 avoids edge contact with the spherical bearing surface 122. The chamfered edge 142 has a width dimension W of approximately 0.1 to 0.3 millimeters. Specifically, the width dimension W of the chamfered edge 142 is 0.2 millimeters. In a typical jigsaw, the bearing surface of the bushing is cylindrical, such that the forward and backward swinging of the slider portion 102 causes edge contact between the slider portion 102 and the bushing 110 leading to excessive wear between the two components.

The jigsaw 10 further includes a quick-disconnect mechanism or a blade ejection mechanism 146 disposed on the housing 14. The blade ejection mechanism 146 is pivotable about output spindle 72 and is configured to selectively lock the saw blade 30 to the output spindle 72. Specifically, the blade ejection mechanism 146 is pivotable from a locked position, in which the saw blade 30 is inhibited from being removed from the output spindle 72, and an unlocked position, in which the saw blade 30 is permitted to be removed from the output spindle 72. FIG. 1 illustrates the blade ejection mechanism 146 being biased toward the locked position.

During operation, a user may grasp the gripping surfaces 42a, 42b of the housing 14 and the handle 18 to maneuver the jigsaw 10 relative to a workpiece. The user may rest the jigsaw 10 on the workpiece via the foot plate 26 and align the saw blade 30 with the desired cut. The saw blade 30 reciprocates within the blade plane 40 in response to the user sliding the activation switch 54 into the activated state. Once the motor 66 is activated, the motor 66 drives rotational movement of the transmission 70 which, in turn, drives reciprocating movement of the counterweight 98 and the output spindle 72. The slider portion 102 converts the rotational movement of the transmission 70 into reciprocating movement of the output spindle 72. The bushing 110 translates through the laterally extending slot 118 of the slider portion 102, thereby driving the output spindle 72 and the saw blade 30 along the vertical axis 94 in the straight cutting mode. When the jigsaw 10 is in the orbital cutting mode, the output spindle 72 and, therefore, the slider portion 102 swing relative to the vertical axis 94 approximately two degrees in response to the support arm 63 imparting an orbit motion to the saw blade 30. The spherical or convex shape of the bearing surface 122 minimizes mechanical interference between the bushing 110 and the laterally extending slot 118 as the slider portion 102 swings relative to the vertical axis 94. Thus, there is less wear and tear on the bushing 110 and the slider portion 102. The chamfered edge 142 also increases longevity of the drive assembly 34 from avoiding edge contact with the bearing surface 122 as the slider portion 102 swings relative to the vertical axis 94.

Although the disclosure has been described in detail with reference to certain preferred embodiments, variations and modifications exist within the scope and spirit of one or more independent aspects of the disclosure as described. Various features and advantages of the disclosure are set forth in the following claims.

What is claimed is:

1. A jigsaw comprising:
a housing;
a handle extending substantially transverse from the housing in a direction along a handle axis;
a battery selectively coupled to the handle;
a foot plate coupled to the housing and configured to contact a workpiece during a cutting operation;
a drive assembly powered by the battery and including a motor, a transmission driven by the motor, an output spindle driven by the transmission and coupled to a saw blade; and
a scotch yoke mechanism to convert a rotational motion of the transmission to a reciprocating motion of the output spindle and the saw blade generally along a vertical axis that is perpendicular to the handle axis,
wherein the scotch yoke mechanism includes a bushing eccentrically mounted to a driven gear of the transmission, the bushing includes a spherical bearing surface received within a laterally extending slot of the output spindle for sliding movement therewith.

2. The jigsaw of claim 1, wherein the bearing surface has a convex cross-sectional shape in a plane containing a central axis of the bushing.

3. The jigsaw of claim 2, wherein the convex cross-sectional shape of the bearing surface has a radius of curvature of up to 30 millimeters.

4. The jigsaw of claim 1, wherein the bearing surface includes an apex that has a diameter that is greater than a diameter of first and second ends of the bearing surface.

5. The jigsaw of claim 1, wherein the output spindle swings forward and backward up to two degrees relative to the vertical axis during an orbital cutting mode.

6. The jigsaw of claim 5, wherein the laterally extending slot includes a chamfered edge to avoid edge contact with the bushing when the output spindle swings relative to the vertical axis.

7. The jigsaw of claim 6, wherein the chamfered edge has a width dimension of approximately 0.2 millimeters.

8. A drive assembly for a jigsaw configured to cut a workpiece during a cutting operation, the jigsaw comprising:
a motor that rotates about a first axis;
an output spindle driven by the motor along a second axis and coupled to a saw blade; and
a scotch yoke mechanism to convert a rotational motion of the motor to a reciprocating motion of the output spindle and the saw blade generally along the second axis that is perpendicular to the first axis,
wherein the scotch yoke mechanism includes a bushing that orbitally rotates about the first axis, the bushing includes a spherical bearing surface received within a laterally extending slot of the output spindle for sliding movement therewith.

9. The drive assembly of claim 8, wherein the bearing surface has a convex cross-sectional shape in a plane containing a central axis of the bushing.

10. The drive assembly of claim 9, wherein the convex cross-sectional shape of the bearing surface has a radius of curvature of up to 30 millimeters.

11. The drive assembly of claim 8, wherein the bearing surface includes an apex that has a diameter that is greater than a diameter of first and second ends of the bearing surface.

12. The drive assembly of claim 8, wherein the output spindle swings forward and backward up to two degrees relative to the second axis during an orbital cutting mode.

13. The drive assembly of claim 12, wherein the laterally extending slot includes a chamfered edge to avoid edge contact with the bushing when the output spindle swings relative to the second axis.

14. The drive assembly of claim 13, wherein the chamfered edge has a width dimension of approximately 0.2 millimeters.

15. A drive assembly for a jigsaw configured to cut a workpiece during a cutting operation, the jigsaw comprising:
a motor;
an output spindle coupled to a saw blade and driven by the motor along an axis that is generally perpendicular to the workpiece; and
a scotch yoke mechanism disposed between the motor and the output spindle and configured to convert a rotational motion of the motor to a reciprocating motion of the output spindle and the saw blade,
wherein the scotch yoke mechanism includes a bushing having a spherical bearing surface received within a laterally extending slot of the output spindle for sliding movement therewith.

16. The drive assembly of claim 15, wherein the bearing surface has a convex cross-sectional shape in a plane containing a central axis of the bushing.

17. The drive assembly of claim 16, wherein the convex cross-sectional shape of the bearing surface has a radius of curvature of up to 30 millimeters.

18. The drive assembly of claim 15, wherein the bearing surface includes an apex that has a diameter that is greater than a diameter of first and second ends of the bearing surface.

19. The drive assembly of claim 15, wherein the output spindle swings forward and backward up to two degrees relative to the axis during an orbital cutting mode.

20. The drive assembly of claim 19, wherein the laterally extending slot includes a chamfered edge to avoid edge contact with the bushing when the output spindle swings relative to the axis, wherein the chamfered edge has a width dimension of approximately 0.2 millimeters.
